(19) United States
(12) Patent Application Publication
(10) Pub. No.: US 2015/0312187 A1
(43) Pub. Date: Oct. 29, 2015

(54) SYSTEMS AND METHODS FOR MODIFYING A RECIPIENT LIST OF A MESSAGE

(71) Applicant: CONVERSEPOINT LLC, Chicago, IL (US)

(72) Inventors: Randall G Menna, Chicago, IL (US); Peter Kelso, Chicago, IL (US)

(73) Assignee: ConversePoint LLC, Chicago, IL (US)

(21) Appl. No.: 14/648,638

(22) PCT Filed: Nov. 29, 2013
(86) PCT No.: PCT/US2013/072510

§ 371 Date: May 29, 2015

Related U.S. Application Data
(60) Provisional application No. 61/732,240, filed on Nov. 30, 2012.

(51) Int. Cl. H04L 12/58

(52) U.S. Cl. CPC H04L 51/12

(57) ABSTRACT

Systems and methods are provided for facilitating an exchange in a messaging conversation between an originating entity and a plurality of recipient entities. According to certain aspects, a facilitating entity receives a message from the originating entity that specifies a list of the plurality of recipient entities. The facilitating entity analyzes the message to determine how to modify the list of the recipient entities and modifies the list according to the analysis. The facilitating entity sends the message to the plurality of recipient entities that are specified by the modified list. In aspects, the facilitating entity can manage rounds of message and response exchanges with one or more of the recipient entities until a predefined criteria is met, or according to other parameters.

### CROSS-REFERENCE TO RELATED APPLICATION

This international application claims priority to U.S. Provisional Application No. 61/732240, filed Nov. 30, 2012, which is incorporated herein by reference in its entirety.

### FIELD

This application generally relates to facilitating a message intended for a plurality of recipient entities. In particular, the application relates to platforms and techniques for modifying a recipient list of the message based on an analysis the message.

### BACKGROUND

With the increasing prevalence of devices and technology offering messaging and general communication capabilities, individuals are able to more easily and frequently communicate with contacts and other individuals. For example, individuals can send emails, text messages, and other data communications to recipients. With the advancing growth of smart phones, there is an ongoing shift in communications from personal messages to group communication. Particularly, in personal messaging, one party communicates with another party and they engage in an exchange of information. In group communication, one party communicates with a group of individuals also for the purpose of exchanging information.

However, deficiencies exist in current group communication technologies and protocols. In particular, simply mapping the techniques of personal messaging to a group does not scale in effectiveness and efficiency. For example, getting the right information to the right individuals, ensuring that the right individual is in the conversation, not overloading certain individuals with useless or irrelevant information, and modifying messages into a format or to contain information that can be readily interpreted or understood by the recipients are all challenges that are not addressed by current group communication technologies.

Accordingly, there is an opportunity to develop techniques for making group communication effective, efficient and reliable. In particular, there is an opportunity to develop techniques for analyzing a message intended for a plurality of recipients to determine how to remove one or more of the plurality of recipients, or add one or more additional recipients, to ensure that the message is sent to relevant recipients. Further, there is an opportunity to develop techniques for facilitating group message exchange to reduce the need for a sender to accurately specify a group of recipients for a message as well as reduce the amount of response messages that are communicated to the sender.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates an existing data communication pattern in accordance with some embodiments.

FIG. 2 illustrates an exemplary data communication pattern in accordance with some embodiments.

FIG. 3 illustrates an exemplary application of the message facilitation techniques in accordance with some embodiments.

FIG. 4 illustrates an exemplary application of the message facilitation techniques in accordance with some embodiments.

FIG. 5 illustrates an exemplary application of the message facilitation techniques in accordance with some embodiments.

FIG. 6 is a block diagram of a device in accordance with some embodiments.

FIG. 7 is a flow diagram depicting message facilitation in accordance with some embodiments.

### DETAILED DESCRIPTION

The present embodiments are defined by the appended claims. This description summarizes some aspects of the present embodiments and should not be used to limit the claims.

Systems and methods are disclosed for facilitating conversational or group messaging, wherein participant entities can exchange messages and message responses in one or more sets or rounds. Contrary to conventional messaging, the systems and methods as described herein describe a facilitating entity capable of analyzing messages associated with the conversation, the messages specifying lists of recipient entities, and modifying the lists of the recipient entities according to the analysis. Using the facilitating entity, the embodiments create conversation construction patterns that may encompass multiple rounds, and where the message facilitation can be directed according to logic, state, and instruction.

The systems and methods support control of message routing and distribution via intercepting messages, analyzing messages, and modifying a list of intended recipients. Particularly, logic and other evaluative techniques can be used to analyze individual and collected messages, message data, and message metadata according to predefined criteria and other parameters. The systems and methods can advantageously make group messaging techniques more effective, efficient and reliable. For example, the facilitating entity, after analyzing a message, can modify the list of recipients for the message to better ensure that the message is sent to the appropriate and relevant recipients. It should he appreciated that the entities as discussed herein can be a human, a system, a system acting on behalf of a human, a corporation, a company, an enterprise, or other types of entities.

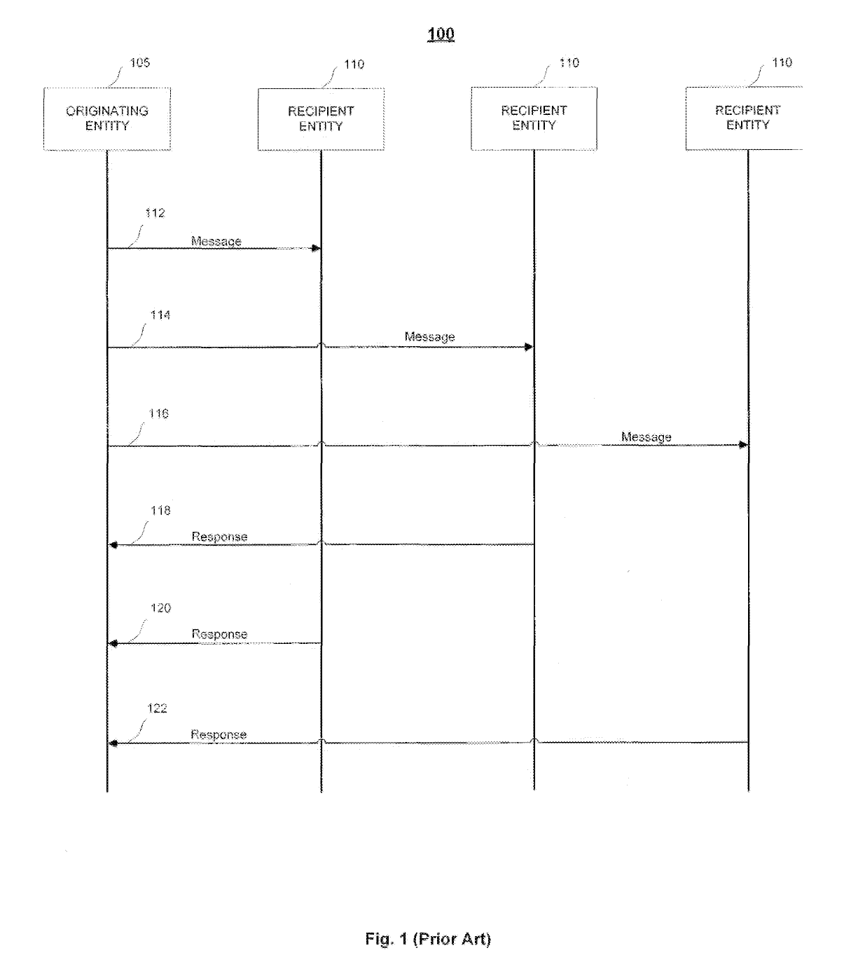

Referring to FIG. 1, depicted is a currently existing communication technology pattern 100 related to sending a message to a plurality of recipient entities. As shown in FIG. 1, the pattern 100 includes an originating entity 105 and three (3) recipient entities 110, wherein the originating entity 105 has a message that it intends to send to each of the recipient entitles 110.

The originating entity 105 sends 112, 114, 116 the message to each of the recipient entities 110. Particularly, the message that is received by the recipient entitles 110 is the same message that is sent by the originating entity 105, without any modification of content associated with the message. As shown in FIG. 1. the originating entity 105 receives 118, 120, 122 various responses from each of the recipient entities 110. For example, the responses can be direct responses to the message sent to the recipient entities 110.

However, there are drawbacks to the existing communication pattern 100 as detailed in FIG. 1. Particularly, the message is always sent to the recipient entities 110 that the originating entity 105 specifies. Accordingly, there is no opportunity to modify which recipient entities are to receive the message before it is sent to the recipient entitles 110. For example, the message may include confidential information that one or more of the recipient entities 110 are not privy to, and/or that the originating entity 105 mistakenly includes in the message. As a result, one or more of the recipient entities 110 may receive message content that they are not authorized to view or access.

Still further the originating entity 105 may know who the proper or most relevant recipients of a message should be. For example, the originating entity 105 may want to query a group of recipients regarding a particular topic, but may nor know which recipients are most equipped or knowledgeable to respond to the query. Further still, the originating entity 105 may not want to receive a response until a certain criteria is met.

Accordingly, there is an opportunity to perform an analysis on a message from an originating entity to determine how to modify a list of intended recipient entities before the message is sent to the recipient entities. As discussed herein, the analysis and the modification can be based on a variety of factors. Further, there is an opportunity to perform an analysis on any return message to determine whether a criteria is met, and optionally further modify the list of intended recipient entities and send the message to the recipient entities specified in the further modified list.

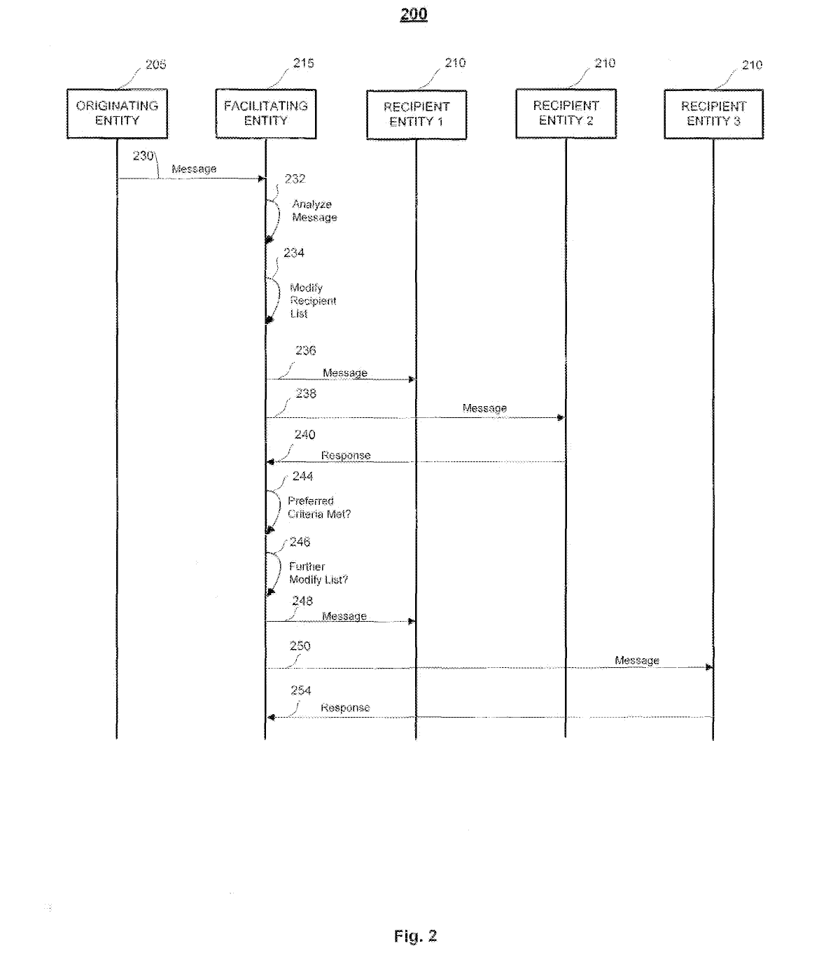

Referring to FIG. 2, depicted is a communication pattern 200 detailing the present embodiments. Similar to the communication pattern 100 of FIG. 1, the communication pattern 200 includes an originating entity 205 and three (3) recipient entities 210. The communication pattern 200 further includes a facilitating entity 215 capable of facilitating messages between and among the originating entity 205 and the recipient entities 210. It should be understood that the facilitating entity 215 can include any combination of hardware and software capable of performing the functionalities as discussed herein. For example, the facilitating entity 215 can be any type of computer, server, or the like. Further, it should be understood that a user can interface with the facilitating entity 215 to provide input for any of the functionalities as discussed herein.

As shown in FIG. 2, the originating entity 205 can send 230 a message to the facilitating entity 215. In embodiments, the message can be any type of data capable of being communicated such as, for example, e-mails, text messages (e.g., SMS, MMS, etc.), voice-to-text messages, electronic documents, or other data types. Further, the message can include content that can be any combination of metadata, body content, header information, and/or the like. According to embodiments, the message can have an associated list or information that identifies recipients to which the message is intended. For example, the list can indicate phone numbers, email addresses, or other identifying information of the intended recipients.

The facilitating entity 215 can analyze 232 the message to determine how to modify the list of intended recipients. In some cases, the analysis can include scanning the message, such as via a lexical analysis, to determine that the list needs to be modified. For example, the analysis can identify various content in the message and, based on the content, identify additional recipients who themselves could benefit from receiving the message or whose receipt of the message could benefit the originating entity 205. For further example, the analysis can identify various content in the message that is germane to an existing conversation occurring between or among other entities. Further, for example, the analysis can identify one or more of the recipient entitles 210 who should not receive the message due to various reasons or concerns such as, for example, security, confidentiality, relevancy, and/or other reasons. Additionally, the analysis can result in a determination that none of the recipient entities 210 should receive the message if, for example, none of the recipient entities 210 are relevant to or allowed to see the content of the message, the message delivery is outside an acceptable time window to send messages, or other concerns or reasons apply. Still further, for example, the message from the originating entity 205 can specify no recipient entities, and the facilitating entity 215 can determine the relevant recipient entities 210 to which to send the message based on various analyses, as discussed herein.

According to some embodiments, the analysis of the message can be performed via user interaction. More particularly, a user can interact with the facilitating entity 215 to examine the message and determine how to modify the list of the recipient entities. In some cases, the facilitating entity 215 can prompt the user with various options to select how to modify the list of the recipient entities. In other cases, the user can manually modify the list of the recipient entities and provide the modified list to the facilitating entity 215. It should be appreciated that other techniques and interactions with the user for analyzing and modifying the list of the recipient entities are envisioned.

The facilitating entity 215 can modify 234 the list of recipient entities according to the analysis. For example, the facilitating entity 215 can add one or more recipient entities to or remove one or more recipient entities from the list. In embodiments, the modified list can include none, some, or all of the recipient entities originally specified in the message. In some eases, the recipient entity list modification can be performed in response to receiving various inputs from a user. In the example as shown in FIG. 2, the modified list of recipient entities specifies that the message should be sent lo recipient entities 1 and 2. Accordingly, the facilitating entity 215 can send 236, 238 the message to the recipient entities 210 specified in the modified list. In embodiments, the message can be sent according to any communication protocol. After sending the message, the facilitating entity can receive 240 a response from one of the recipient entities 210. For example, in the case as shown in FIG. 2, the response is received from recipient entity 2. Although not shown in FIG. 2, it should be appreciated that other responses can be received from others of the recipient entities 210.

The facilitating entity 215 can determine 244 if a predefined criteria has been met. In embodiments, the predefined criteria can be based on one or more factors relating to the responses or the communication in general. In one embodiment, the predefined criteria can be an amount of time allotted for responses from the recipient entities 210 to be received. The amount of time can be a fixed amount of time or can be formulaically determined based on various factors. In other embodiments, the predefined criteria can be based on an amount or percentage of the recipient entities 210 who respond. For instance, the predefined criteria can be met if the facilitating entity 215 receives responses from at least 50% of the recipient entities 210. For further instance, the predefined criteria can be met if the facilitating entity 215 receives a single response, receives multiple responses, receives a response with certain content, or receives one or more responses from one or more specific recipient entities. In other embodiments, the predefined criteria can be met if, after analyzing the content of the received response, the facilitating entity 215 determines that the response is sufficient to send to the originating entity 205. It should be appreciated that other predefined criteria are envisioned. In embodiments, if the predefined criteria is met, the facilitating entity 215 can terminate the conversation. In some cases, the facilitating entity 215 can send any received responses, a summary report, and/or other content to the originating entity 205.

If the predefined criteria is not met, the facilitating entity 215 can determine 246 if an additional modification to the list of recipient entities is needed. Particularly, any responses received from the recipient entitles 210 may not have been sufficient and the facilitating entity 215 can determine that one or more extra rounds of message exchange with other various recipient entities are needed. For example, the facilitating entity 215 can determine that the original message was not delivered to the relevant recipient entities and that the message needs to be delivered to an additional one or more recipient entities.

If no additional motivation to the list is needed, then the facilitating entity 215 can terminate the conversation, wait for more responses, or perform other functions. If additional modification is needed, then the facilitating entity 215 can modify the list of recipient entities accordingly and send 248, 250 the message to the recipient entities 210 specified in the further modified list. In the example as shown in FIG. 2, the further modified list of recipient entities specifies that the message should be sent to recipient entities 1 and 3. The facilitating entity can receive 254 a response from one of the recipient entities 210, in this case recipient entity 3. Although not shown in FIG. 2, it should be appreciated that other responses can be received from others of the recipient entities 210. Further, although not shown in FIG. 2, the facilitating entity 215 can analyze the response and determine if a predefined criteria is met and/or if additional modification to the list of recipient entities is needed, as discussed herein, and can send the message to others of the recipient entities 210 where necessary.

Further embodiments envision multiple facilitating entities 215. For example, a first facilitating entity can perform an analysis on the message received from the originating entity 205 and send the message and analysis to an additional facilitating entity for further analysis and/or to modify the list of the recipient entities. It should be appreciated that the multiple facilitating entities 215 can perform functionalities in parallel or in sequence.

Still further embodiments envision the facilitating entity 215 invoking various systems or applications in response to various triggers. For example, the various systems and applications can be billing systems, calendaring systems, external delivery systems, archiving systems, and others. Further, the triggers can be related to the listing of the recipient entities specified in the message received from the originating entity 205 or can be based on the responses received from the recipient entities. The system or application invocation can be a part of the analysis to determine how to modify the list of recipient entities. In some cases, the triggers can be in response to the conversation terminating. It should be appreciated that other various systems, applications, and triggers are envisioned.

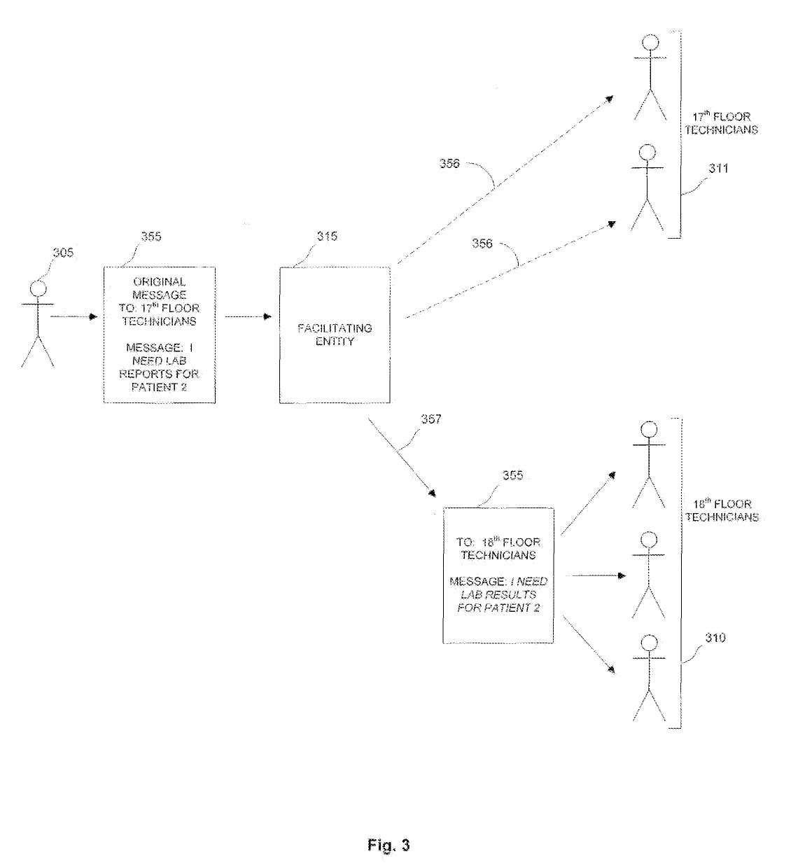

Referring to FIG. 3, depicted is an exemplary application of the functionalities as described herein. In particular, FIG. 3 depicts a situation where a message from an originating entity 305 and intended for a first set of recipient entities is analyzed and redirected to a second set of recipient entities.

As shown in FIG. 3, the originating entity 305 can send a message 355 to a facilitating entity 315. The message 355 can indicate a group of recipient entities (as shown: 17th floor technicians 311) and a message body (as shown: “I need lab results for Patient 2”). In some embodiments, the originating entity 305 need not specify specific recipient entities in the message 355. Instead, the message 355 can identify a group and the facilitating entity 315 can store a listing of the recipient entities that are a part of that identified group. For example, in the exemplary application as depicted in FIG. 3, the facilitating entity 315 can store identification and contact information for various lab technicians. Upon receipt of the message 355, the facilitating entity 315 can analyze the message 355 to determine how to modify the list of recipient entities. For example, in the situation as shown in FIG. 3, the facilitating entity 355 can determine that the lab results for Patient 2 could best be retrieved by the 18th floor technicians 310. Accordingly, the facilitating entity 355 can replace the 17th floor technicians 311 with the 18th floor technicians 310 on the list of recipient entities.

Sending the message 355 for analysis by the facilitating entity 315 is advantageous to the originating entity 305 because the originating entity 305 may not know, may be speculating, or may be mistaken as to whom to send the message 355. For example, as shown in FIG. 3, the originating entity 305 may think that the 17th floor technicians 311 are most equipped to retrieve the lab results for Patient 2. The facilitating entity 315 can have access to data or information that may be useful in modifying the list of recipient entities and directing the message 355 to those recipient entities. For example, in the situation as shown in FIG. 3, the facilitating entity 315 can access a database that indicates that the 18th floor technicians 310 have access to the lab results tor a certain group of patients. Accordingly, instead of the message 355 being sent (356) to the 17th floor technicians 311 who may not know or have access to the lab results for Patient 2, the facilitating entity 315 sends (357) the message 355 to the 18th floor technicians 310 who can be more equipped to supply the requested results.

In embodiments, one or more of the recipient entities (18th floor technicians) 310 can provide responses to the message 355 to the facilitating entity 315. For example, one of the recipient entities 310 can send the lab results for Patient 2 to the facilitating entity 315. Although not depicted in FIG. 3, the facilitating entity 315 can analyze any received responses to determine if the content satisfies the request specified in the message 355. If the content does not satisfy the request, the facilitating entity 315 can further modify the list of recipient entities and send the message 355 to those recipient entities. If the content does satisfy the request, then the facilitating entity 315 can forward the response received from the applicable recipient entity 310 to the originating entity 305. It should be appreciated that other round facilitation and conversation termination criteria are envisioned. Further, it should be appreciated that similar conversation patterns are envisioned.

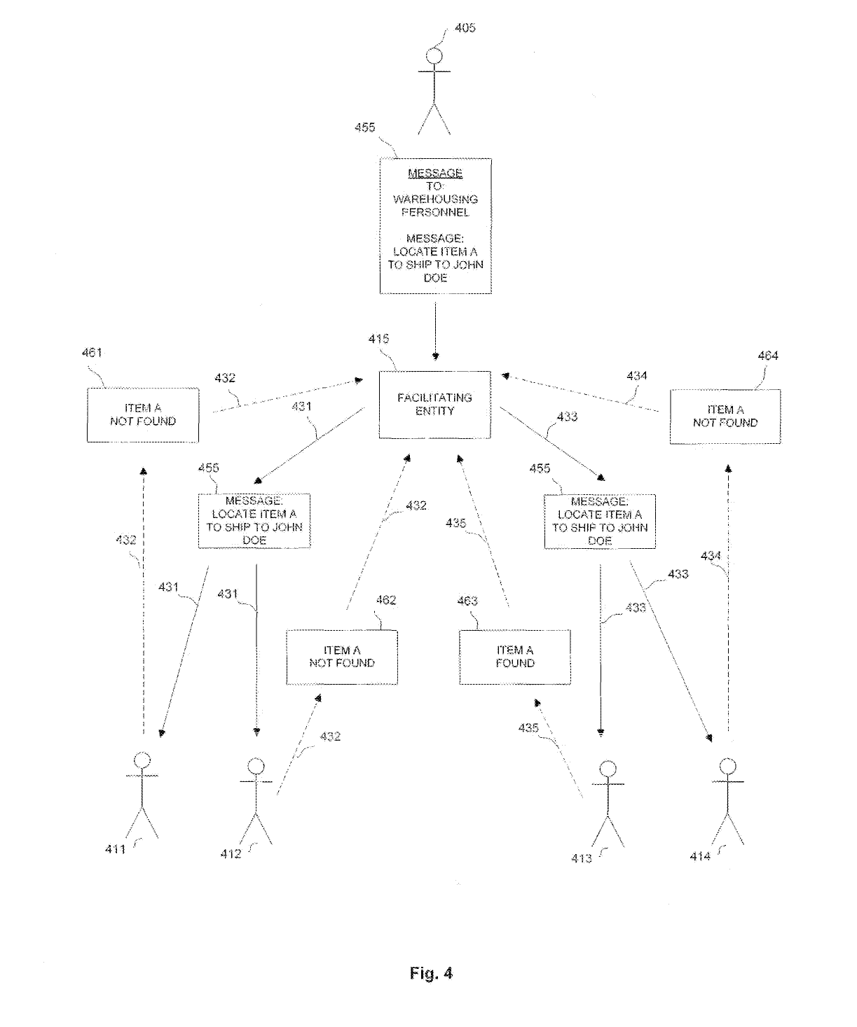

Referring to FIG. 4, depicted is an additional exemplary application of the functionalities as described herein. In particular, FIG. 4 depicts a situation wherein an originating entity 405 wishes to have an item located and shipped to a specific customer. The exemplary application can be useful in, for example, supply chain management, warehousing, and other workflows.

As shown in FIG. 4, the originating entity 405 can send a message 455 to a facilitating entity 415. The message 455 can specify a listing of recipient entities (as shown: warehouse personnel 411, 412, 413, 414) and message content (as shown: locate item A to ship to John Doe). Particularly, the originating entity 405 may wish to have Item A shipped to John Doe, but may not know which of the warehouse personnel has access to item A or can otherwise locate Item A. The facilitating entity 415 can receive the message 455 and analyze the message 455 to determine how to modify the listing of recipient entities. For example, the facilitating entity 415 can determine that sending the message 455 to all of the warehouse personnel 411, 412, 413, 414 would lead to confusion and/or too many of the warehouse personnel 411, 412, 413, 414 attempting to locate Item A. Accordingly, the facilitating entity 415 can determine or identify a subset of the warehouse personnel 411, 412, 413, 414 to which to send the message 455.

As shown in FIG. 4, the facilitating entity 415 can identify warehouse personnel 411, 412 as the two recipients who are to first receive the message 455. Accordingly, the facilitating entity 415 can send (431) the message 455 to each of the warehouse personnel 411, 412. In response to receiving the message 455, each of the warehouse personnel 411, 412 can attempt to locate Item A according to the information in the message 455. Further, each of the warehouse personnel 411, 412 can send a response to the facilitating entity 415. A shown in FIG. 4, the warehouse personnel 411, 412 can send (432) respective responses 461, 462 that each indicated that Item A was not found.

In response to receiving the responses 461, 462 from the warehouse personnel 411, 412, the facilitating entity 415 can determine if a predefined criteria has been met. Particularly, in the situation as depicted in FIG. 4, the facilitating entity 415 can analyze the responses 461, 462 to determine if Item A was located. Because neither of the warehouse personnel 411, 412 was able to locate Item A, the facilitating entity 415 can determine that the predefined criteria has not been met. In response to the determination, the facilitating entity 415 can identify an additional set of recipients to whom to send the message 455. In the situation as depicted in FIG. 4, the second set of recipients can be the remaining warehouse personnel 413, 414 who have not yet received the message 455. It should be appreciated that the additional set of recipients can be determined in any way and according to any criteria.

As shown in FIG. 4, the facilitating entity 415 can send (433) the message 455 to each of the remaining warehouse personnel 413, 414. In response to receiving the message 455, each of the remaining warehouse personnel 413, 414 can attempt to locate Item A, as specified in the message 455. Further, each of the remaining warehouse personnel 413, 414 can send a response to the facilitating entity 415. A shown in FIG. 4, the warehouse personnel 414 can send (434) a response 464 that indicates that Item A was not found. Further, the warehouse personnel 413 can send (435) a response 463 that indicates that item A was found.

As described herein, in response to receiving the responses 463, 464 from the remaining warehouse personnel 413, 414, the facilitating entity 415 can determine if the predefined criteria has been met. Particularly, in the situation as depicted in FIG. 4, the facilitating entity 415 can analyze the responses 463, 464 to determine if Item A was located. Because the warehouse personnel 413 was able to locate Item A, the facilitating entity 415 can determine that the predefined criteria has been met. Accordingly, the facilitating entity 415 can inform the originating entity 405 that the predefined criteria has been met, can send a report to the originating entity 405, and/or can perform other functions.

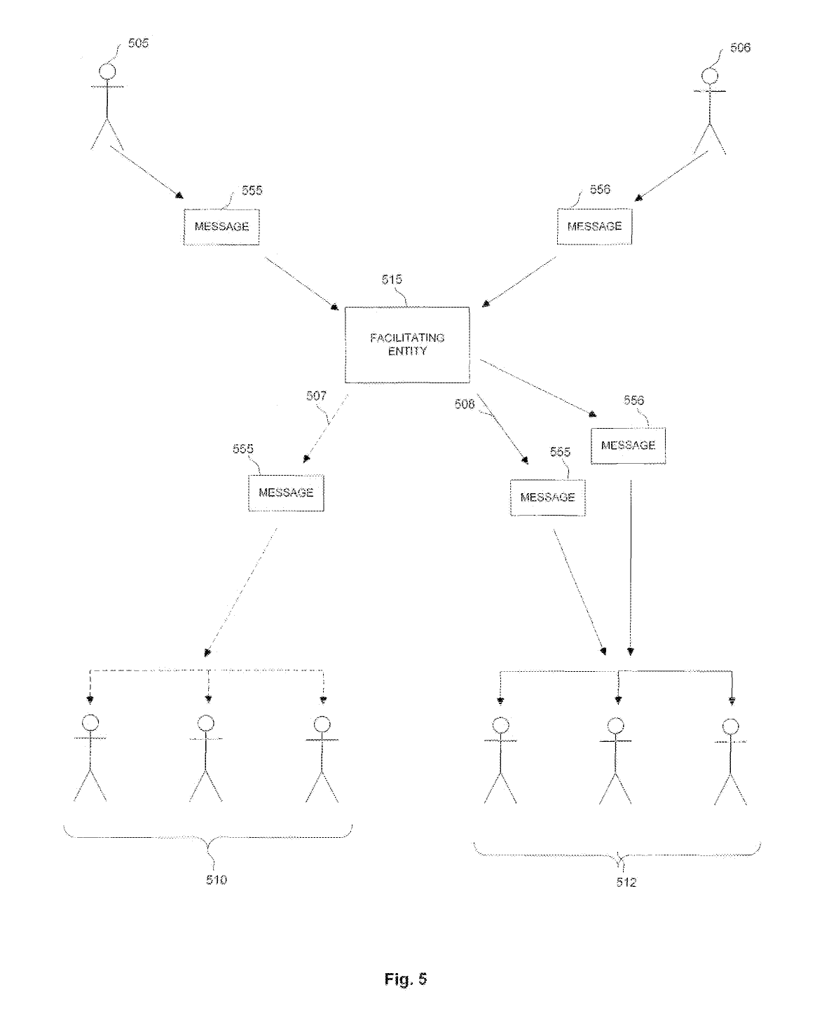

Referring to FIG. 5, depicted is an additional exemplary application of the functionalities as described herein. In particular, FIG. 5 depicts a situation wherein a facilitating entity 515 forwards a message originally intended for a first set of recipient entities 510 to a second set of recipient entities 512.

As shown in FIG. 5, a first originating entity 505 can send a message 555 to the facilitating entity 515. According to embodiments, the message 555 can specify that it is to be sent to each the first set of recipient entities 510. Particularly, the message 555 can include a list specifying the first set of recipient entities 510. As further shown in FIG. 5, a second originating entity 506 can also be in communication with the facilitating entity 515, which can be in communication with the second set of recipient entities 512. Particularly, the second originating entity 506 can send a message 556 to the second set of recipient entities 512 via the facilitating entity 515. In other words, the second originating entity 506 can be in a conversation, or a message/response exchange, with the second set of recipient entities 512 that is separate from a conversation between the first originating entity 505 and the first set of recipient entities 510.

According to embodiments, the facilitating entity 515 can receive the message 555 from the first originating entity 505 and analyze the message 555 to determine how to modify the list of intended recipient entities. As discussed herein, the analysis of the message 555 can be based on one or more various factors. For example, the facilitating entity 515 can scan the message 555, such as via a lexical analysis, to determine how to modify the list. In embodiments as shown in FIG. 5, the facilitating entity 515 can determine that various content of the message 555 is more relevant to the conversation between the second originating entity 506 and the second set of recipient entities 512. For example, the message 555 may contain a question that has already been answered in messages exchanged between and among the second originating entity 506 and the second set of recipient entities 512. In this example, the facilitating entity 515 can be aware of the content that is exchanged between the second originating entity 506 and the second set of recipient entities 512.

According to embodiments, instead of sending (507) the message 555 to the first set of recipient entities 510, the facilitating entity 515 can send (508) the message 555 to each of the second set of recipient entities 512. In some embodiments, the facilitating entity 515 can also send the message 555 to the first set of recipient entities 510. In some cases, the facilitating entity 515 can modify the message 555 that it sends to the second set of recipient entities 512 to indicate that the message 555 originates from an third party entity (here: the first originating entity 505). This can reduce any confusion on the part of the second set of recipient entitles 512 that may result from receiving a message containing content that has already been addressed. In some embodiments, after receiving the message 555, one of more of the second set of recipient entities 512 can send a response to the first originating entity 505 via the facilitating entity 515. Further, the first originating entity 505 can continue the conversation with any of the first set of recipient entities 510 and/or the second set of recipient entities 512 until predefined criteria or other parameters are fulfilled.

For am example of the disclosed application, assume that all of the first originating entity 505, second originating entity 506, first set of recipient entities 510, and second set of recipient entities 512 are employed by the same company. Further, the first originating entity 505 desires to know where a specific presentation file and thinks that the one of the first set of recipient entities 510 may know where the presentation file is located. Accordingly, the first originating entity 505 sends an email intended for the first set of recipient entities 510 that queries the location of the presentation file. The facilitating entity 515 receives and examines the email, and determines that the second originating entity 506 has already asked the second set of recipient entities 512 where the same presentation file is located. Accordingly, instead of sending the email to the first set of recipient entities 510, the facilitating entity 515 sends the email to the second set of recipients 512.

One or more of the second set of recipients 512 can send an email response back to the first originating entity 505, via the facilitating entity 515, that indicates the location of the presentation file. By the facilitating entity 515 redirecting the email to a more relevant group of recipient entities, the originating entity 505 can receive an answer to its query in a shorter amount of time, in addition to other benefits, such as if none of the first set of recipient entities 510 know where the presentation file is located.

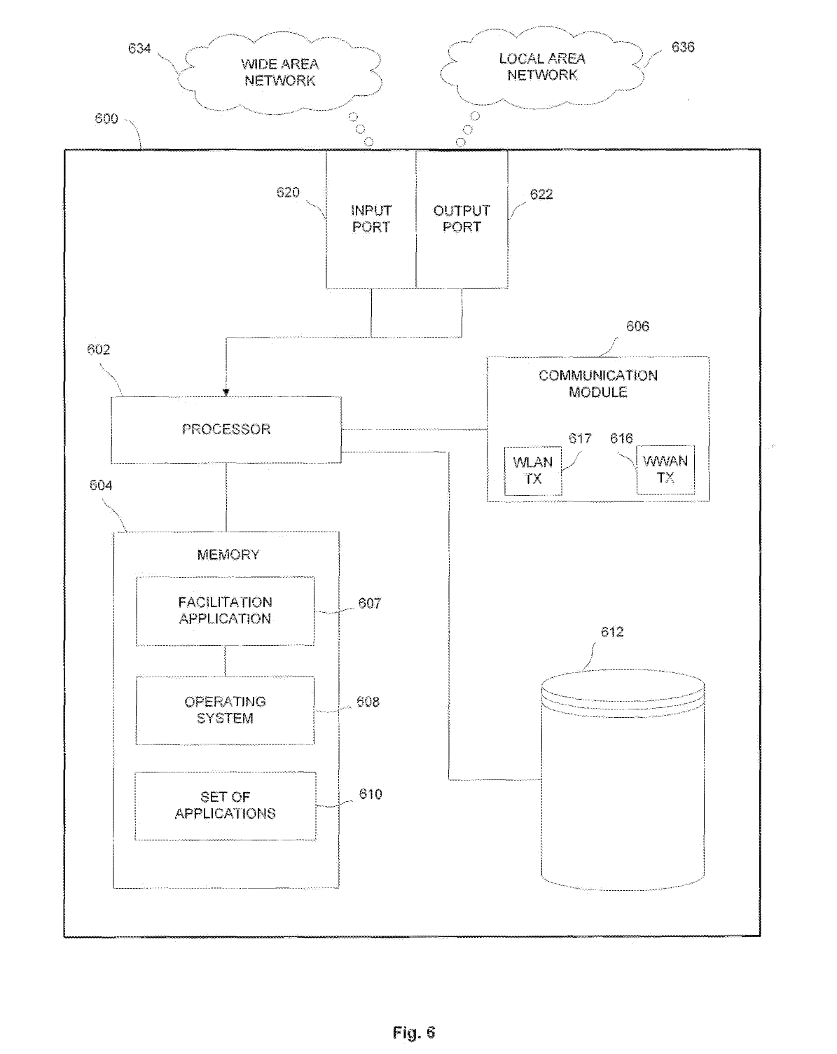

Referring to FIG. 6, depicted is an exemplary server 600 and components thereof. More particularly, the server 600 can be a combination of hardware and software components associated with the facilitating entity as discussed herein. It should be appreciated that FIG. 6 represents a generalized schematic illustration and that other hardware and software components can be added or existing components can be removed or modified.

As shown in FIG. 6, the server 600 can comprise a set of ports that can receive input signals or data from, or output signals or data to, other components of a communication environment, such as the originating entity 205 and the recipient entities 210 as discussed with respect to FIG. 2. More particularly, an input port 620 can receive cellular or other types of data from a wide area network 634 (such as various private or public networks) or a local area network 636 (such as a wireless local area network (WLAN)), and an output port 622 can output data to the wide area network 634 or the local area network 636. Although not shown in FIG. 6, the systems and methods envision other types of wired or wireless networks through which data can be communicated.

The server 600 can further comprise a processor(s) 602 communicating with a memory 604, such as electronic random access memory (RAM), or other forms of transitory or non-transitory computer readable storage mediums, operating under control of or in conjunction with an operating system 608. The operating system 608 can be any commercial, open-source, or proprietary operating system or platform. The processor 602 can communicate with a database 612, such as a database stored on a local hard drive. While illustrated as a local database in the server 600, the database 612 can be separate from the server 600.

The processor 602 can further communicate with a communication module 606, such as a wired or wireless data connection, which in turn communicates with the wide area network 634 and the local area network 636. In particular, the communication module 606 can comprise a WWAN transceiver 616 capable of communicating with the wide area network 634 and a WLAN transceiver 617 capable of communicating with the local area network 636. The set of ports 620, 622 of the server 600 can use the components of the communication module 606 to connect to any of the entitles as discussed herein. For example, the input port 620 can receive a message from the originating entity 205 via the WWAN transceiver 616, and the output port 622 can send the message to the recipient entities 610 via the WWAN transceiver 616. The processor 602 can also communicate with a set of applications 610 that can be configured to execute control logic and perform data processing to perform the functions and techniques as discussed herein. For example, the set of applications 610 can comprise a facilitation application 607 that can support the functionalities of the message facilitation, as described herein. It should be appreciated that other applications 610 and functionalities thereof are envisioned.

While FIG. 6 illustrates the server 600 as a standalone system using a combination of hardware and software, the components of the server 600 can also be implemented as a software application or program capable of being executed by a conventional computer platform. Likewise, the components of the server 600 can also be implemented as a software module or program module capable of being incorporated in other software applications and programs. In either case, the components of the server 600 can be implemented in any type of conventional proprietary or open-source computer language.

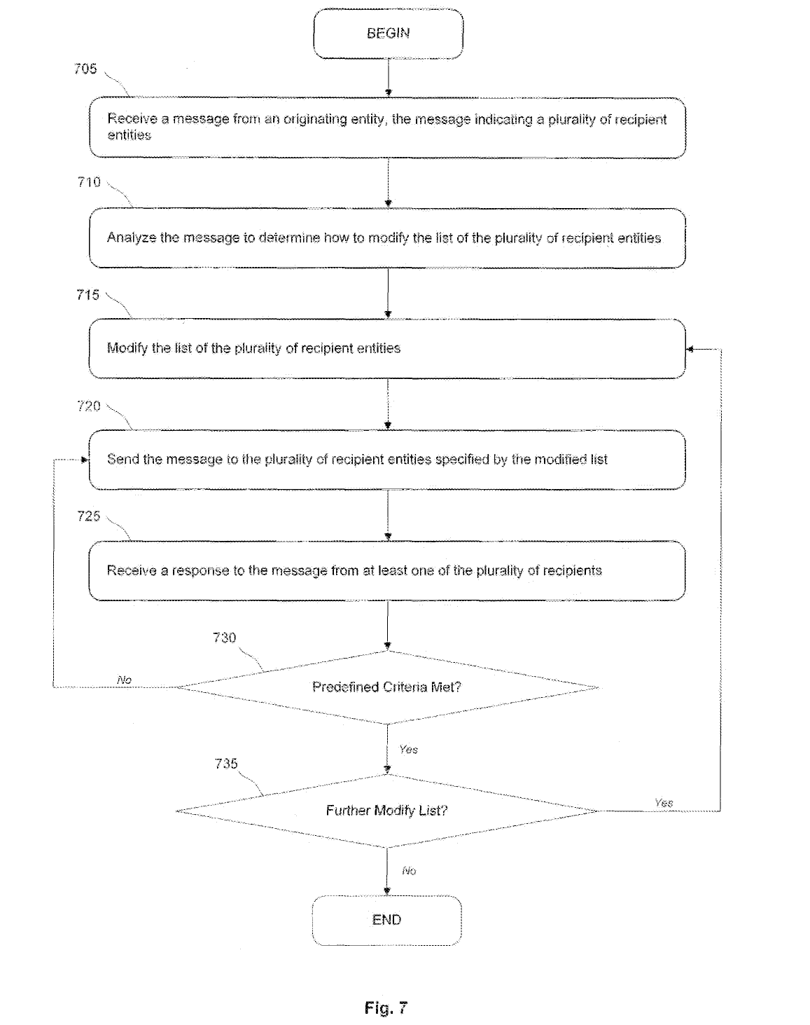

FIG. 7 is a flowchart of a method 700 for a facilitating entity (such as the facilitating entity 215 as discussed with respect to FIG. 2) to facilitate the delivery of a message intended for a plurality of recipient entities. More particularly, the method 700 relates to the facilitating entity modifying a list of recipient entities and sending the message to the recipient entities specified by the modified list.

The method 700 begins with the facilitating entity receiving 705 a message from an originating entity, the message indicating a list of a plurality of recipient entities. Particularly, the originating entity can be in a conversation with the plurality of recipient entities specified by the list and, in some cases, the list can be a part of the metadata of the message. The facilitating entity analyzes 710 the message to determine how to modify the list of the plurality of recipient entities. For example, the facilitating entity can analyze the content of the message to determine that the message should be sent to at least one additional recipient entity in addition to those that the list specifies. For further example, the facilitating entity can analyze the list itself to determine that one or more of the recipient entities should be removed from the list.

The facilitating entity modifies 715 the list of the plurality of recipient entities according to the analysis and sends 720 the message to plurality of recipient entities specified by the modified list. It should be appreciated that sending the message can be accomplished via any type of communication protocol. The facilitating entity receives 725 a response to the message from at least one of the plurality of recipient entitles. For example, the message sent to the plurality of recipient entities can include a specific query, and the response can be an answer to the query. It should be appreciated that other various message and response styles or formats are envisioned.

The facilitating entity determines 730 if a predefined criteria has been met. For example, if the message sent to the plurality of recipient entities is a query, the predefined criteria can be met when the facilitating entity receives an answer to the query versus, for example, a follow-up question. If the predefined criteria is not met (“NO”), then processing can optionally proceed to 720 where the facilitating entity re-sends the message to the plurality of recipient entities specified by the modified list, or return to any previous functionality. If the predefined criteria is met (“YES”), then the facilitating entity determines 735 whether to further modify the list. For example, additional list modification may be needed if the facilitating entity identities or determines that additional recipient entities should receive the message. If additional modification is needed (“YES”), processing can proceed to 715 where the facilitating entity further modifies the list of the plurality of recipient entities. If no additional modification is needed (“NO”), then processing can end, repeat, or return to any previous functionality. In some cases, the facilitating entity can further modify the list if the predefined criteria is met.

Thus, it should be clear from the preceding disclosure that the system and method effectively and efficiently manages a message exchange between an originating entity and a plurality of recipient entities. The system and method advantageously allows a facilitating entity to redirect a message that is originally intended for a first group of recipient entities to a second group of recipient entities that may be more relevant to receive the message. Further, the system and method can facilitate message and response exchange between the facilitating entity and the recipient entities before the facilitating entity reports any results to the originating entity.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method of managing a conversation between an originating entity and a plurality of recipient entities, the method comprising:
receiving, at a first computer, a message from the originating entity, the message indicating a list of the plurality of recipient entities;
analyzing, by the first computer, the message to determine how to modify the list of the plurality of recipient entities;
modifying, using the first computer, the list of the plurality of recipient entities according to the analyzing; and
sending the message to the plurality of recipient entities specified by the list that was modified.

2. The method of claim 1, wherein analyzing the message to determine how to modify the list comprises:
querying an entity to modify the list of the plurality of recipient entities; and
receiving, from the entity, a modification to the list of the plurality of recipient entities.

3. The method of claim 1, wherein analyzing the message to determine how to modify the list comprises determining a first group comprising a first recipient entity of the plurality of recipient entities, and wherein sending the message comprises:
sending the message to the first recipient entity of the first group;
in response to sending the message, determining whether a predefined criteria is met;
if the predefined criteria is not met;
determining a second group comprising a second recipient entity of the plurality of recipient entities, and
sending the message to the second recipient entity of the second group.

4. The method of claim 1, wherein analyzing the message to determine how to modify the list comprises:
identifying an additional recipient entity outside the conversation that is relevant to the conversation and that is to he added to the list of the plurality of recipient entities.

5. The method of claim 1, wherein analyzing the message to determine how to modify the list comprises:
identifying a recipient entity of the plurality of recipient entities that is not relevant to the conversation and that is to be removed from the list of the plurality of recipient entities.

6. The method of claim 1, wherein analyzing the message to determine how to modify the list comprises:
analyzing the message to determine that the message is relevant to an additional conversation in which at least one additional recipient entity is participating, wherein the at least one additional recipient entity is to be added to the list of the plurality of recipient entities.

7. The method of claim 1, wherein sending the message to the plurality of recipient entities specified by the list that was modified comprises:
analyzing the list that was modified to determine that none of the plurality of recipient entities are specified; and
refraining from sending the message to the plurality of recipient entities specified by the list that was modified.

8. A system for managing a conversation between an originating entity and a plurality of recipient entities, the system comprising:
a server comprising a communication module for sending and receiving messages associated with the conversation; and
a processor coupled to the server and configured to perform operations comprising:
receiving a message from the originating entity, the message indicating a list of the plurality of recipient entities,
analyzing the message to determine how to modify the list of the plurality of recipient entities,
modifying the list of the plurality of recipient entities according to the analyzing, and
sending the message to the plurality of recipient entities specified by the list that was modified.

9. The system of claim 8, wherein analyzing the message to determine how to modify the list comprises:
querying an entity to modify the list of the plurality of recipient entities; and
receiving, from the entity, a modification to the list of the plurality of recipient entities.

10. The system of claim 8, wherein analyzing the message to determine how to modify the list comprises determining a first group comprising a first recipient entity of the plurality of recipient entities, and wherein sending the message comprises:
sending the message to the first recipient entity of the first group;
in response to sending the message, determining whether a predefined criteria is met;
if the predefined criteria is not met:
determining a second group comprising a second recipient entity of the plurality of recipient entities, and
sending the message to the second recipient entity of the second group.

11. The system of claim 8, wherein analyzing the message to determine how to modify the list comprises:
identifying an additional recipient entity outside the conversation that is relevant to the conversation and that is to be added to the list of the plurality of recipient entitles.

12. The system of claim 8, wherein analyzing the message to determine how to modify the list comprises:
identifying a recipient entity of the plurality of recipient entities that is not relevant to the conversation and that is to be removed from the list of the plurality of recipient entities.

13. The system of claim 8, wherein analyzing the message to determine how to modify the list comprises:
analyzing the message to determine that the message is relevant to an additional conversation in which at least one additional recipient entity is participating, wherein the at least one additional recipient entity is to be added to the list of the plurality of recipient entities.

14. The system of claim 8, wherein sending the message to the plurality of recipient entities specified by the list that was modified comprises:
analyzing the list that was modified to determine that none of the plurality of recipient entities are specified; and
refraining from sending the message to the plurality of recipient entities specified by the list that was modified.

15. A non-transitory computer readable medium comprising computer instructions embodied thereon to:
cause a processor to receive a message from the originating entity, the message indicating a list of the plurality of recipient entities;
cause the processor to analyze the message to determine how to modify the list of the plurality of recipient entities;
cause the processor to modify the list of the plurality of recipient entities according to the analyzing; and
cause the processor to send the message to the plurality of recipient entities specified by the list that was modified.

16. The non-transitory computer readable medium of claim 15, wherein analyzing the message to determine how to modify the list comprises:
querying a user to modify the list of the plurality of recipient entities; and
receiving, from the user, a modification to the list of the plurality of recipient entities.

17. The non-transitory computer readable medium of claim 15, wherein analyzing the message to determine how to modify the list comprises determining a first group comprising a first recipient entity of the plurality of recipient entities, and wherein sending the message comprises:
sending the message to the first recipient entity of the first group;
in response to sending the message, determining whether a predefined criteria is met;
if the predefined criteria is not met:
determining a second group comprising a second recipient entity of the plurality of recipient entities, and
sending the message to the second recipient entity of the second group.

18. The non-transitory computer readable medium of claim 15, wherein analyzing the message to determine how to modify the list comprises:
identifying an additional recipient entity outside the conversation that is relevant to the conversation and that is to be added to the list of the plurality of recipient entities.

19. The non-transitory computer readable medium of claim 15, wherein analyzing the message to determine how to modify the list comprises:
identifying a recipient entity of the plurality of recipient entities that is not relevant to the conversation and that is to be removed from the list of the plurality of recipient entities.

20. The non-transitory computer readable medium of claim 15, wherein analyzing the message to determine how to modify the list comprises:
analyzing the message to determine that the message is relevant to an additional conversation in which at least one additional recipient entity is participating, wherein the at least one additional recipient entity is to be added to the list of the plurality of recipient entities.
